(19) United States
(12) Patent Application Publication
(10) Pub. No.: US 2010/0033284 A1
(43) Pub. Date: Feb. 11, 2010

(54) RESONANCE TRANSFORMER AND POWER SUPPLY UNIT EMPLOYING IT

(75) Inventors: Kazuhiko Yamakami, Osaka (JP); Wataru Tabata, Osaka (JP); Hidenori Uematsu, Osaka (JP); Hamazou Hagino, Osaka (JP); Chiaki Tachioka, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/722,934

(22) PCT Filed: Feb. 22, 2006
(86) PCT No.: PCT/JP2006/303118

§ 371 Date: Jun. 27, 2007

(30) Foreign Application Priority Data
Feb. 28, 2005 (JP) 2005-052851
Jan. 31, 2006 (JP) 2006-022031

(51) Int. Cl. H01F 27/29; H01F 17/04

(52) U.S. Cl. 336/192; 336/221

(57) ABSTRACT

A resonance type transformer has an O-shaped magnetic core, a primary winding, and a secondary winding. The O-shaped magnetic core is formed of a first split magnetic core and a second split magnetic core, and has a first magnetic leg provided with a first magnetic gap therein and a second magnetic leg opposite the first magnetic leg. The primary winding is wound on the outer periphery of the first magnetic so as to cover at least the first magnetic gap. The secondary winding is wound on the outer periphery of the second magnetic leg.

This application is a U.S. national phase application of PCT International Application No. PCT/JP2006/303118.

### TECHNICAL FIELD

The present invention relates to a resonance type transformer for use in various electronic devices and an electric power supply unit using the same.

### BACKGROUND ART

FIGS. 13 and 14 are sectional views of a conventional resonance type transformer. FIG. 14 shows the flow of magnetic flux. This resonance type transformer includes B-shaped magnetic core 4 formed by putting together E-shaped magnetic cores 2A, 2B, primary winding 10 and secondary winding 12 respectively wound around central magnetic legs 6A, 6B via bobbin 8.

Magnetic gap 14 is provided between central magnetic legs 6A, 6B, and primary winding 10 and secondary winding 12 are disposed adjacently with each other in the vicinity of magnetic gap 14. Central magnetic leg 6A is longer than central magnetic leg 6B, and magnetic gap 14 is formed by putting magnetic legs 6A, 6B face to face.

Electric current resonance can be caused by connecting a resonance capacitor and a switching element in series with the leakage inductance of primary winding 10 of the resonance transformer. This type of resonance transformer is disclosed in Japanese Patent Unexamined Publication No. H08-064439, for example.

In the above-described conventional structure, primary winding 10 and secondary winding 12 are disposed adjacently with each other in the vicinity of magnetic gap 14. For this reason, as shown in FIG. 14, a portion of magnetic flux 16 generated by primary winding 10 becomes leakage magnetic flux 18 without passing through B-shaped magnetic core 4 and directly interlinks with secondary winding 12. As a result, an eddy current is generated in secondary winding 12 due to leakage magnetic flux 18 thus resulting in a temperature rise in secondary winding 12 due to the eddy current and causing degradation of characteristic.

### SUMMARY OF THE INVENTION

The present invention provides a resonance type transformer in which temperature rise in the secondary winding is suppressed and the characteristic is enhanced. The resonance type transformer in accordance with the present invention has an O-shaped magnetic core, a primary winding and a secondary winding. The O-shaped magnetic core is formed of a first split magnetic core and a second split magnetic core and has a first magnetic leg that is provided with a first magnetic gap therein and a second magnetic leg opposite the first magnetic leg. The primary winding is wound around the outer periphery of the first magnetic leg so as to cover at least the first magnetic gap. The secondary winding is wound around the outer periphery of the second magnetic leg. With this structure, a part of the magnetic flux generated by the primary winding and directly interlinking with the secondary winding without passing through the O-shaped magnetic core is decreased. That is, the eddy current generated in the secondary winding is suppressed thus suppressing temperature rise in the secondary winding due to the eddy current.

### BRIEF DESCRIPTION OF DRAWINGS

FIG. 1 is an exploded perspective view of a resonance type transformer in an exemplary embodiment of the present invention.

FIG. 2 is an exploded perspective view of the rear side of the resonance type transformer shown in FIG. 1.

FIG. 3 is a perspective view of an O-shaped magnetic core used in the resonance type transformer shown in FIG. 1.

FIG. 4 is a perspective view of the resonance type transformer shown in FIG. 1.

FIG. 5 is a perspective view of the resonance type transformer of FIG. 4 before applying a case.

FIG. 6 is a sectional view of the resonance type transformer shown in FIG. 1.

FIG. 7 is a circuit diagram of a power supply unit that uses the resonance type transformer shown in FIG. 1.

FIG. 8 is a sectional view showing the flow of magnetic flux in the resonance type transformer of FIG. 6.

FIG. 9 is a characteristic diagram showing the relationship between the aspect ratio of cross section of the magnetic core and leakage inductance.

FIG. 10 is a characteristic diagram showing the relationship between the aspect ratio of cross section of the magnetic core and coupling coefficient.

FIG. 11 is a sectional view of another resonance type transformer in the exemplary embodiment of the present invention.

FIG. 12 is a sectional view of still another resonance type transformer in the exemplary embodiment of the present invention.

FIG. 13 is a sectional view of a conventional resonance type transformer.

FIG. 14 is a sectional view showing the flow of magnetic flux in the resonance type transformer of FIG. 13.

### DETAILED DESCRIPTION OF PREFERRED EMBODIMENT

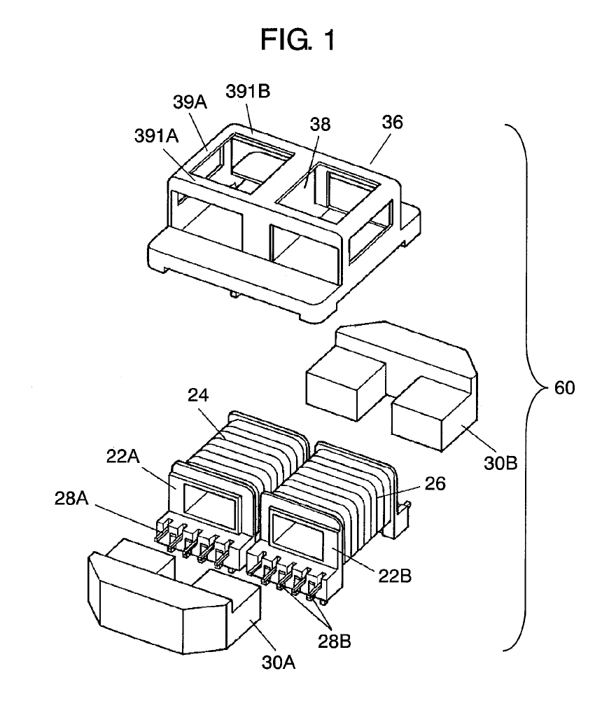

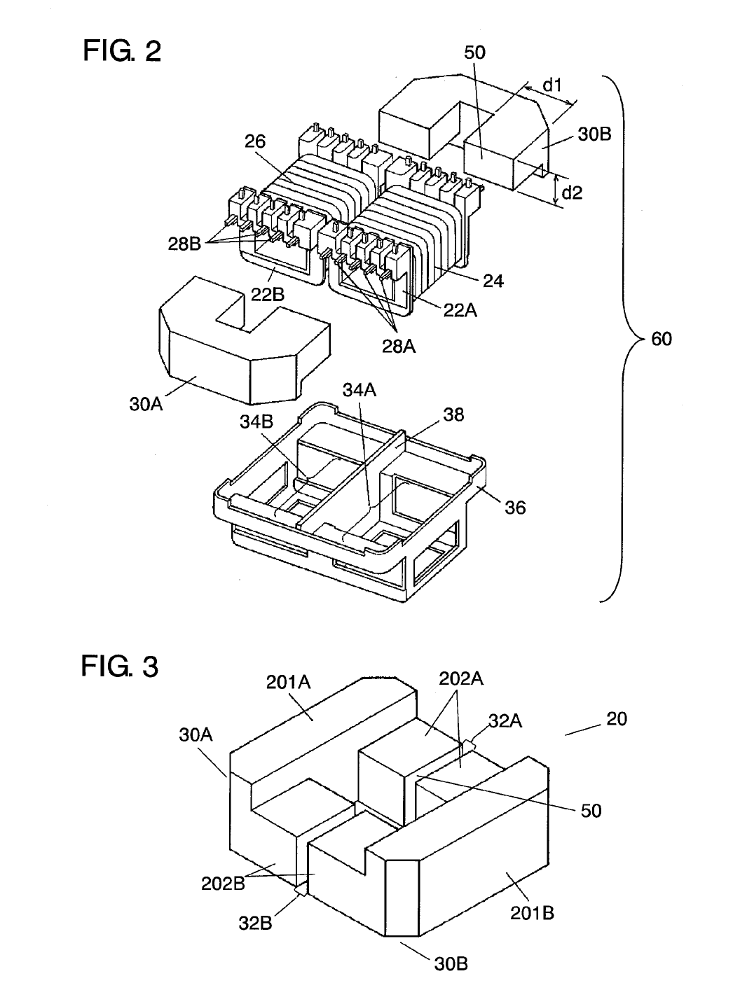

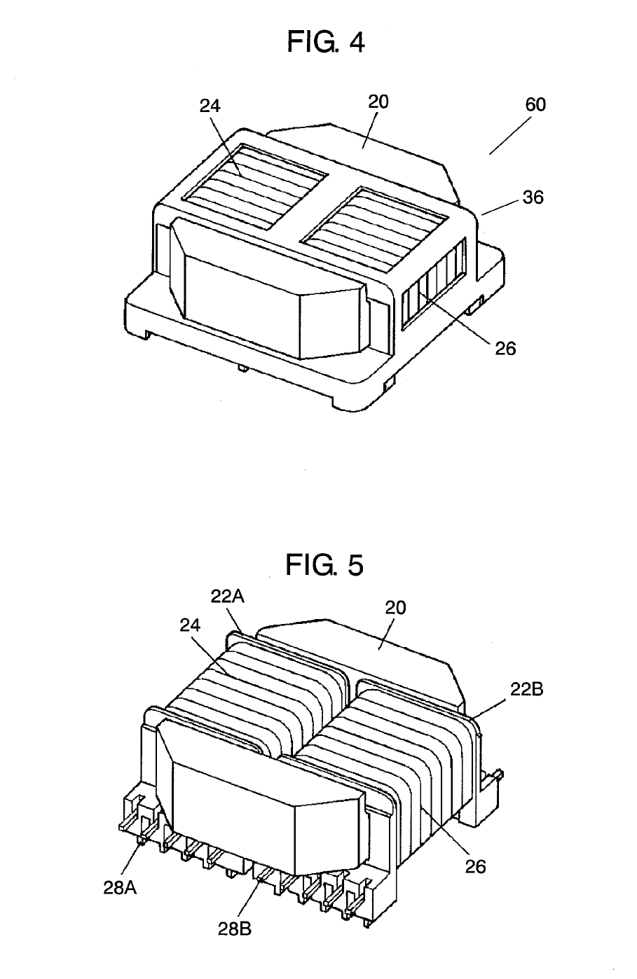

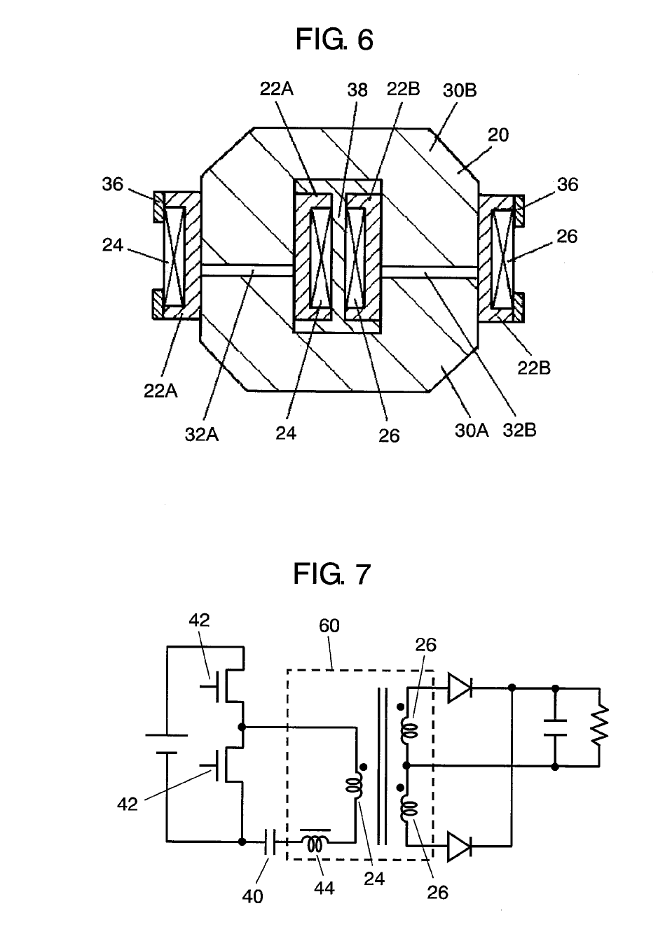

FIG. 1 is an exploded perspective view of a resonance type transformer in an exemplary embodiment of the present invention. FIG. 2 is an exploded perspective view of rear side of the resonance type transformer. FIG. 3 is a perspective view of an O-shaped magnetic core. FIG. 4 is a perspective view of the resonance type transformer. FIG. 5 is a perspective view of the resonance type transformer before being encased. FIG. 6 is a sectional view of the resonance type transformer.

Resonance type transformer 60 in the exemplary embodiment of the present invention has O-shaped magnetic core 20, primary winding 24, and secondary winding 26. O-shaped magnetic core 20 comprises back portions 201A, 201B, first magnetic legs 202A, and second magnetic leg 202B. O-shaped magnetic core 20 is formed in a manner such that first and second C-shaped magnetic cores 30A, 30B, being first and second split magnetic cores, faces each other with each respective end portion opposing through respective first and second magnetic gaps 32A, 32B. Magnetic leg 202A is provided with magnetic gap 32A therein, magnetic leg 202B is provided with magnetic gap 32B therein and is opposite magnetic leg 202A.

Primary winding 24 is wound on the outer periphery of magnetic leg 202A via first bobbin 22A while secondary winding 26 is wound on the outer periphery of magnetic leg 202B via second bobbin 22B. Primary winding 24 and secondary winding 26 are wound so as to cover magnetic gaps 32A, 32B, respectively. That is, bobbin 22A is disposed between outer periphery of magnetic leg 202A and primary winding 24 and is wound with primary winding 24. Bobbin 22B is disposed between outer periphery of magnetic leg 202B and secondary winding 26 and is wound with secondary winding 26.

Primary winding 24 and secondary winding 26 are litz wires prepared by twisting about 150 copper wires having electrically insulating coating with each end connected respectively to first and second terminals 28A, 28B implanted in bobbins 22A, 22B. Each of terminals 28A, 28B includes a terminal section for wiring and a terminal section for mounting.

C-shaped magnetic cores 30A, 30B are made from manganese based ferrite, nickel based ferrite, or dust core, for example. Bobbins 22A, 22B are made of an electrically insulating resin such as phenol resin, polyethylene terephthalate (PET), and polybutylene terephthalate (PBT).

Furthermore, resonance type transformer 60 has case 36 provided with first and second recesses 34A, 34B which match the outer configurations of bobbins 22A, 22B. Case 36 is made of an electrically insulating resin similar to that of bobbins 22A, 22B. Case 36 covers O-shaped magnetic core 20 and makes bobbins 22A, 22B fit into recesses 34A, 34B. Or, bobbins 22A, 22B are bonded with the case at recesses 34A, 34B respectively. By either of this method, bobbins 22A, 22B and O-shaped magnetic core 20 are positioned and secured in case 36. In case 36, electrically insulating wall 38 is provided between bobbins 22A, 22B for separation and insulation between bobbins 22A, 22B.

FIG. 7 is a circuit diagram of an electric power supply unit that uses resonance type transformer 60 structured as described above. Such a power supply unit is used for video systems using a plasma display or a liquid crystal display, for example. Such electric power supply unit reduces an input voltage of 400V to an output voltage of 24V with a drive frequency of 40 kHz to 100 kHz. This electric power supply unit is provided with resonance capacitor 40 and switching element 42 which are connected to primary winding 24. Resonance type transformer 60 is driven by current resonance caused by leakage inductance 44 induced in primary winding 24, resonance capacitor 40 and switching element 42. This electric power supply unit is used by setting leakage inductance 44 at between several tens to several hundreds of pH and the capacitance of resonance capacitor 40 to not greater than 1 μF.

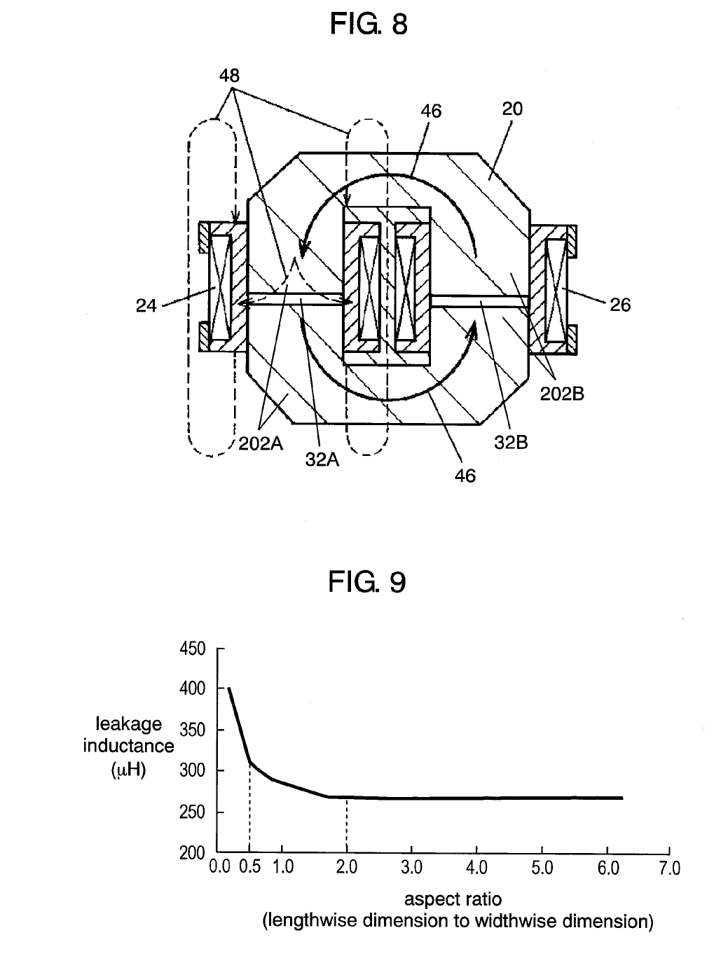

FIG. 8 is a sectional view showing the flow of magnetic flux in resonance type transformer 60. Primary winding 24 is wound on magnetic leg 202A and secondary winding 26 is wound on magnetic leg 202B. Primary winding 24 is wound on the portion where magnetic gap 32A is provided. Accordingly, most of magnetic flux 46 generated by primary winding 24 either circulates inside O-shaped magnetic core 20, or becomes leakage magnetic flux 48 and circulates inside primary winding 24 without circulating inside O-shaped magnetic core 20. Accordingly, there is little possibility of leakage magnetic flux 48 to interlink with secondary winding 26 which is disposed adjacently to primary winding 24. That is, the eddy current generated in secondary winding 26 due to interlinkage with secondary winding 26 is suppressed thereby suppressing temperature rise in secondary winding 26.

In particular, primary winding 24 and secondary winding 26 are wound around mutually opposite magnetic legs 202A, 202B, respectively. As a result, leakage magnetic flux 48 generated by primary winding 24 and directly interlinking with secondary winding 26 is further reduced thereby suppressing temperature rise in secondary winding 26. With the suppression of the temperature rise, the temperature rises in both primary winding 24 and secondary winding 26 are controlled to around 40K, which is lower than the temperature rise in conventional resonance type transformers.

In case 36, insulating wall 38 is provided at a position between primary winding 24 and secondary winding 26. With this arrangement, primary winding 24 and secondary winding 26 are not spatially electrically insulated over a distance in a straight line but along a further longer creeping distance due to insulating wall 38. This is preferable as higher electrical insulation can be maintained.

Beam 39A on the lengthwise side of case 36 extends in the direction to contact O-shaped magnetic core 20 as shown in FIG. 1. Beam 391A on the widthwise side of case 36 extends toward widthwise beam 391B on the opposite side in a manner closing the opening. That is, case 36 includes beams 39A, 391A, 391B provided between bobbins 22A, 22B and O-shaped magnetic core 20. This structure provides a long creeping distance between electro-conductive O-shaped magnetic core 20 and primary and secondary windings 24, 26 owing to beam 39A and beam 391A or beam 391B thus assuring high electrical insulation. Here, though beams 391A, 391B may be extended lengthwise until opening is completely closed, it is preferable to leave an opening in order to suppress temperature rise in primary winding 24 and secondary winding 26.

O-shaped magnetic core 20 is formed by making C-shaped magnetic cores 30A, 30B face each other, and primary winding 24 and secondary winding 26 are wound on portions including opposing portions of C-shaped magnetic cores 30A, 30B. As a result, leakage magnetic flux 48 without going inside O-shaped magnetic core 20 and leaking from magnetic gaps 32A, 32B provided in the opposing parts is interrupted by primary winding 24 and secondary winding 26. As a result, the influence on other mounted components is suppressed.

As shown in FIG. 2, it is preferable to make the ratio of lengthwise dimension d2 to widthwise dimension d1 of opposing face 50 at magnetic gap 32A to at least 0.5 but no more than 2.0. With this limitation, leakage magnetic flux 48 from magnetic gap 32A shown in FIG. 8 can be suppressed and, at the same time, the coupling between primary winding 24 and secondary winding 26 is enhanced.

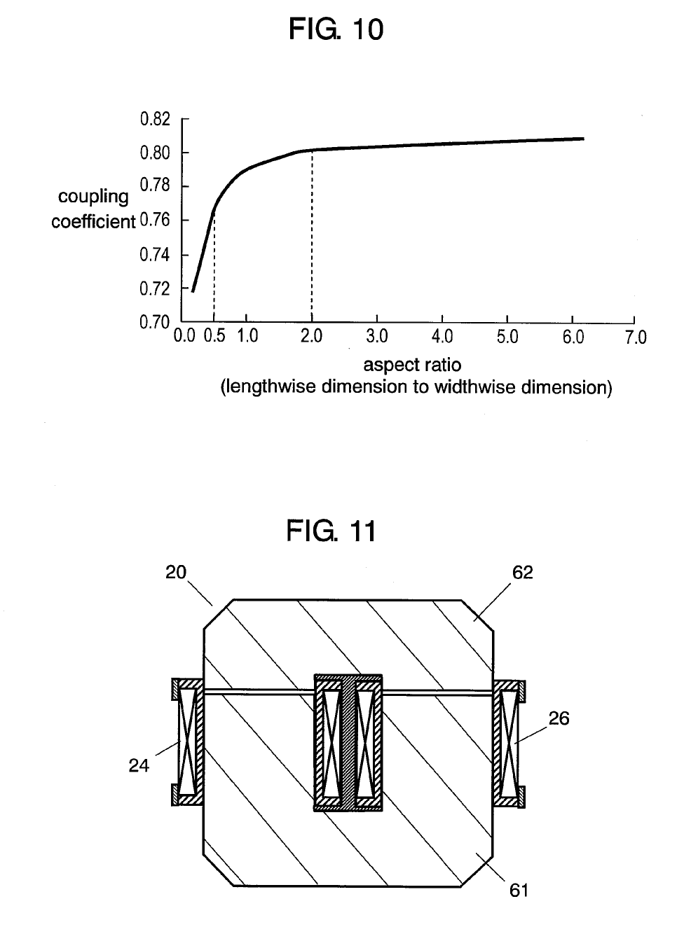

When the ratio d2/d1 decreases toward 0.5, leakage inductance increases and coupling coefficient decreases as the opposing area between primary winding 24 and secondary winding 26 decreases. Conversely, when the ratio d2/d1 increases toward 2.0, the leakage inductance decreases and the coupling coefficient increases as the opposing area between primary winding 24 and secondary winding 26 increases. A detailed description will be given on this aspect referring to FIGS. 9 and 10.

FIG. 9 is a characteristic diagram showing the relationship between the leakage inductance and the ratio d2/d1 of lengthwise dimension d2 to widthwise dimension d1 of opposing face 50 shown in FIG. 2. FIG. 10 is a characteristic diagram showing the relationship between the coupling coefficient and d2/d1.

When the ratio d2/d1 is smaller than 0.5, the climb gradient of the leakage inductance becomes steep as shown in FIG. 9. Also, the decline gradient of the coupling coefficient becomes steep as shown in FIG. 10. Accordingly, in such a range, large dispersion in the characteristics of the leakage inductance and the coupling coefficient tends to be caused due to a small dimensional variation of opposing face 50 while manufacturing C-shaped magnetic cores 30A, 30B. On the other hand, when the ratio of lengthwise dimension d2 to widthwise dimension d1 on opposing face 50 is greater than 2.0, the variations in both the leakage inductance and coupling coefficient are small as shown in FIG. 9 and FIG. 10. That is, the influence of dimensional ratio on the characteristic is small. However, when the ratio d2/d1 is greater, the height of a product becomes higher thus resulting in a possible decrease in stability when mounting or inability to meet requirement for a thinner design. For the above reasons, product dimensions that are adequate for electrical characteristic and assembling can be obtained by making the ratio of lengthwise dimension d2 to widthwise dimension d1 of opposing face 50 at least 0.5 and at greatest 2.0.

Although alternating current resistance component of secondary winding 26 increases by driving at a high frequency, the alternating current resistance component can be reduced by using a litz wire for secondary winding 26. So, it is preferable to use a litz wire for secondary winding 26. As the temperature rise in secondary winding 26 can be suppressed as described above, alternating current resistance component associated with a temperature rise can also be reduced. Accordingly, even when the number of copper wires to be twisted into a litz wire is reduced, the characteristics are not impaired. A smaller size and cost reduction can thus be achieved.

Primary winding 24 and secondary winding 26 are wound via bobbins 22A. 22B, and case 36 for securing bobbins 22A, 22B is provided. As a result, positioning of terminals 28A, 28B implanted in bobbins 22A, 22B is made possible thus improving ease of mounting on a circuit board.

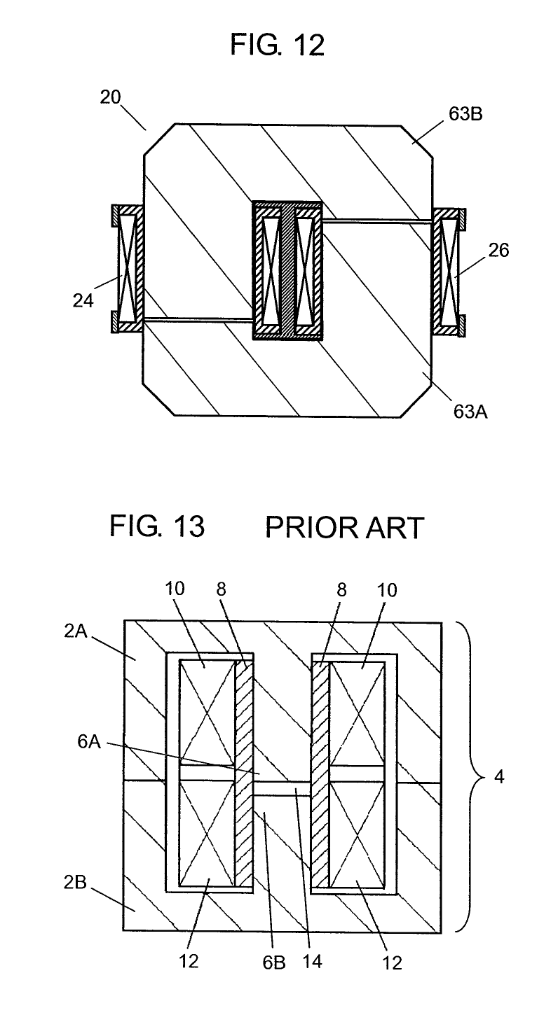

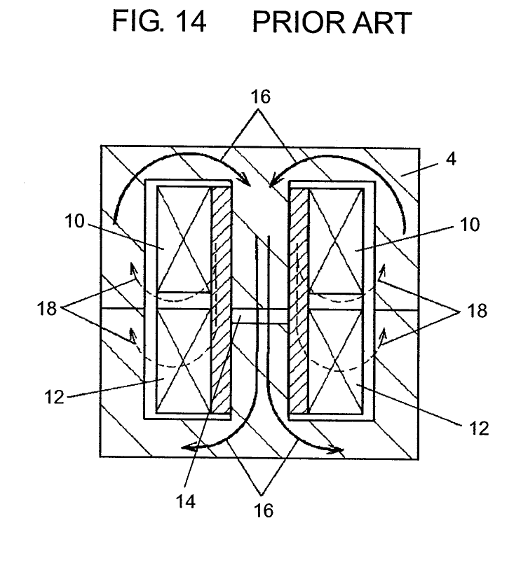

O-shaped magnetic core 20 may be formed not only by oppositely facing C-shaped magnetic cores 30A, 30B but also by composing the first and the second split magnetic cores with U-shaped magnetic core 61 and I-shaped magnetic core 62 and making them face each other as shown in FIG. 11. Also, the first and the second split magnetic cores may be formed by making two L-shaped magnetic cores 63A, 63B face each other as shown in FIG. 12. Even in such cases, the temperature rise in secondary winding 26 can be suppressed as described above by disposing the magnetic gap provided between the first and the second split magnetic cores so as to be covered by primary winding 24. Here, high productivity can be obtained by using C-shaped magnetic cores 30A, 30B or L-shaped magnetic cores 63A, 63B as the two split magnetic cores have the same configurations. Furthermore, by using C-shaped magnetic cores 30A, 30B, magnetic gap 32A can be disposed in the vicinity of the center of primary winding 24. This is preferable because leakage magnetic flux 48 can be securely led to inside primary winding 24.

Depending on the configuration of the split magnetic cores used, bobbins 22A, 22B may not be necessary. However, productivity of primary winding 24 and secondary winding 26 may be improved by using bobbins 22A, 22B.

### INDUSTRIAL APPLICABILITY

In the resonance type transformer in accordance with the present invention, as the temperature rise in the secondary winding can be suppressed and the characteristics are improved, it can be used in a variety of electronic devices.

1. A resonance type transformer comprising:
an O-shaped magnetic core composed of a first split magnetic core and a second split magnetic core and having a first magnetic leg provided with a first magnetic gap therein and a second magnetic leg opposite the first magnetic leg;
a primary winding wound on an outer periphery of the first magnetic leg so as to cover at least the first magnetic gap; and
a secondary winding wound on an outer periphery of the second magnetic leg.

2. The resonance type transformer according to claim 1, wherein the second magnetic leg is provided with a second magnetic gap therein and the secondary winding is wound so as to cover at least the second magnetic gap.

3. The resonance type transformer according to claim 1 further comprising:
a first bobbin provided between the outer periphery of the first magnetic leg and the primary winding and wound with the primary winding, and
a second bobbin provided between the outer periphery of the second magnetic leg and the secondary winding and wound with the secondary winding.

4. The resonance type transformer according to claim 3, wherein
the first bobbin has a first terminal including a terminal section for wiring and a terminal section for mounting, and the second bobbin has a second terminal including a terminal section for wiring and a terminal section for mounting.

5. The resonance type transformer according to claim 3 further comprising a case configured to secure the first bobbin, the second bobbin and the O-shaped magnetic core.

6. The resonance type transformer according to claim 5, wherein
the case is provided with a first recess fitting with the first bobbin and a second recess fitting with the second bobbin.

7. The resonance type transformer according to claim 5, wherein
the case has an electrically insulating wall provided between the first bobbin and the second bobbin.

8. The resonance type transformer according to claim 5, wherein
the case has a beam provided between the first bobbin and the O-shaped magnetic core and between the second bobbin and the O-shaped magnetic core.

9. The resonance type transformer according to claim 1, wherein
the ratio of a lengthwise dimension to a widthwise dimension of an opposing face at the first magnetic gap of the first magnetic leg is at least 0.5 and at greatest 2.0.

10. The resonance type transformer according to claim 1, wherein
the secondary winding is formed of a litz wire.

11. The resonance type transformer according to claim 1, wherein
the first split magnetic core and the second split magnetic core are C-shaped and the O-shaped magnetic core is formed by making ends of each C-shaped magnetic core face each other.

12. An electric power supply unit comprising:
a resonance type transformer as defined in claim 1;
a resonance capacitor connected to the primary winding of the resonance type transformer; and
a switching element connected to the primary winding of the resonance type transformer; wherein
current resonance is caused by leakage inductance of the resonance type transformer, the resonance capacitor, and the switching element.
